(19) United States
(12) Patent Application Publication
(10) Pub. No.: US 2025/0019321 A1
(43) Pub. Date: Jan. 16, 2025

(54) COATED FERTILIZER GRANULE COMPOSITIONS

(71) Applicant: Dow Global Technologies LLC, Midland, MI (US)

(72) Inventors: Alex J. Kosanovich, Manvel, TX (US); Praveen Agarwal, Lake Jackson, MI (US); Juan Carlos Medina, Lake Jackson, TX (US); Yasmin N. Srivastava, Sugar Land, TX (US); Maria Jose Cotanda Santapau, Pearland, TX (US); Yi Fan, Sugar Land, TX (US)

(73) Assignee: Dow Global Technologies LLC, Midland, MI (US)

(21) Appl. No.: 18/714,316

(22) PCT Filed: Nov. 29, 2022
(86) PCT No.: PCT/US2022/051126

§ 371 Date: May 29, 2024

Related U.S. Application Data
(60) Provisional application No. 63/284,693, filed on Dec. 1, 2021.

(51) Int. Cl. C05G 5/30; C05C 9/00

(52) U.S. Cl. CPC C05G 5/37; C05C 9/00; C05G 5/38

(57) ABSTRACT

Embodiments of the present disclosure are directed towards coated fertilizer granule compositions that include three polyurethane layers and two wax layers.

### FIELD OF DISCLOSURE

Embodiments of the present disclosure are directed towards coated fertilizer granule compositions.

### BACKGROUND

Coatings on fertilizer have been used for controlled release of the fertilizer. Controlled release of fertilizer can increase the efficiency of the fertilizer, lower the cost of labor associated with fertilizing, and/or reduce the quantity of fertilizer applications. For some coated fertilizers, water exposure can cause early and/or unintended release of the fertilizer. There exists a continuing need for new coated fertilizers and new methods of making coated fertilizers.

### SUMMARY

The present disclosure provides coated fertilizer granule compositions including a first polyurethane layer contacting fertilizer granules, wherein the first polyurethane layer is made by reacting a high ethylene oxide content polyether polyol and a first polyurethane layer isocyanate in the presence of a first polyurethane layer tertiary amine catalyst; a first wax layer contacting the first polyurethane layer; a second polyurethane layer contacting the first wax layer, wherein the second polyurethane layer is made by reacting a high propylene oxide content polyether polyol and a second polyurethane layer isocyanate in the presence of a second polyurethane layer tertiary amine catalyst; a second wax layer contacting the second polyurethane layer; and a third polyurethane layer contacting the second wax layer, wherein the third polyurethane layer is made by reacting castor oil and a third polyurethane layer isocyanate in the presence of a third polyurethane layer tertiary amine catalyst.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION

Coated fertilizer granule compositions are disclosed herein. The coated fertilizer granule compositions may be referred to as comprising five layers, i.e., three polyurethane layers and two wax layers. Embodiments provide that the five layers are concentric relative to one another. The coated fertilizer granule compositions include a first polyurethane layer contacting fertilizer granules, wherein the first polyurethane layer is made by reacting a high ethylene oxide content polyether polyol and a first polyurethane layer isocyanate in the presence of a first polyurethane layer tertiary amine catalyst; a first wax layer contacting the first polyurethane layer; a second polyurethane layer contacting the first wax layer, wherein the second polyurethane layer is made by reacting a high propylene oxide content polyether and a second polyurethane layer isocyanate in the presence of a second polyurethane layer tertiary amine catalyst; a second wax layer contacting the second polyurethane layer; and a third polyurethane layer contacting the second wax layer, wherein the third polyurethane layer is made by reacting castor oil and a third polyurethane layer isocyanate in the presence of a third polyurethane layer tertiary amine catalyst. Advantageously, the coated fertilizer granule compositions disclosed herein can provide improved, i.e., reduced, fertilizer release.

The coated fertilizer granule compositions disclosed herein include fertilizer granules. The fertilizer granules can comprise urea, nitrogen, phosphorus, or potassium sources such as ammonium nitrate, ammonium sulfate, ammonium sulfate nitrate, calcium nitrate, calcium ammonium nitrate, urea-formaldehyde, monoammonium phosphate, diammonium phosphate, polyphosphate compounds, phosphate rock, single superphosphate, triple super phosphate, potassium nitrate, potassium chloride, potassium sulfate, or combinations thereof, for instance. In some embodiments, the fertilizer granules comprise urea. For instance, the fertilizer granules can have a nitrogen-phosphorus-potassium ratio of 46-0-0. The amounts of nitrogen, phosphorus, or potassium sources included in the fertilizer granules can be varied based on the intended end use and can be 0 to 60 wt. % for each component, based on the total weight of the fertilizer granule.

Additionally, magnesium sulfate and a source of one or more trace elements, i.e., micronutrients can be included, for example boron, calcium, chlorine, cobalt, copper, iron, manganese, molybdenum, nickel, sodium, zinc, or combinations thereof can be present. These nutrients may be supplied in elemental form or in the form of salts, for example as sulfates, nitrates, or halides. The amount of micronutrients can depend on the intended end use and can be varied. For example, the amount of micronutrients can be from 0.1 to 5 weight percent (wt. %), based on the total weight of the fertilizer granule.

Fillers can be utilized in the fertilizer granules, for example bentonite, calcite, calcium oxide, calcium sulfate (anhydrous or hemihydrate), dolomite, talc, sand, or a combination thereof may be utilized.

Other components of the fertilizer granules can include, for example, surfactants, nucleation agents, or recycled fertilizer particles, which can act as a source of nucleating agents, nucleating soil conditioners such as calcium carbonate, activated carbon, elemental sulfur, biocides such as pesticides, herbicides, or fungicides, wicking agents, wetting agents, heat stabilizers, adhesives such as cellulose, polyvinyl alcohols, fats, oils, gum arabics, vinylidene ultraviolet stabilizers, antioxidants, reducing agents, colorants, binders, i.e., organochlorides, zeins, gelatins, chitosan, polyethylene oxide polymers, and acrylamide polymers and copolymers, and the like, as well as combinations thereof.

The fertilizer granules can have any shape or size desired for their intended use. In some embodiments the fertilizer granules are substantially spherical. The fertilizer granules can have an average particle diameter of 0.5 to 6.0 millimeters (mm). All individual values and subranges from 0.5 to 6.0 mm are included; for example, for the fertilizer granules can have an average particle diameter from a lower limit of 0.5, 1.0 or 1.5 mm to an upper limit of 6.0, 5.5, or 5.0 mm. In some embodiments at least 90% by weight of the fertilizer granules have a particle diameter of 2.0 to 4.0 mm Particle diameter can be determined according to “Size Analysis—Sieve Method” IFDC S-107 issued by International Fertilizer Development Center (IFDC) which is a common and internationally approved method used to determine fertilizer particle size.

The coated fertilizer granule compositions include a first polyurethane layer contacting, e.g., coating, the fertilizer granules. As used herein, coating refers to covering, e.g., being formed on, from 90% to 100% of the surface area, e.g., outermost area, of the fertilizer granules. All individual values and subranges from 90% to 100% are included; for example, for the first polyurethane layer can cover from a lower limit of 90, 95, or 96% to an upper limit of 100, 99, or 98% of the surface area of the fertilizer granules.

Embodiments provide that the first polyurethane layer is made by reacting a high ethylene oxide content polyether polyol and a first polyurethane layer isocyanate in the presence of a first polyurethane layer tertiary amine catalyst.

As used herein, “high ethylene oxide content polyether polyol” refers to a polyether polyol that is produced by polymerization of ethylene oxide and optionally another alkylene oxide and an initiator, where ethylene oxide is 80 wt % or more of the total alkylene oxide content of the high ethylene oxide content polyether polyol. Examples of other alkylene oxides that may be utilized include propylene oxide, butylene oxide, and combinations thereof. Embodiments provide that the ethylene oxide is from 80 to 100 wt % of the total alkylene oxide content of the high ethylene oxide content polyether polyol. All individual values and subranges from 80 to 100 wt % are included; for example, the ethylene oxide can be from a lower limit of 80, 90, or 95 wt % to an upper limit of 100, 99, 98, or 97 wt % of the total alkylene oxide content of the high ethylene oxide content polyether polyol. One or more embodiments provide that ethylene oxide is 100 wt % of the total alkylene oxide content of the high ethylene oxide content polyether polyol (i.e., other alkylene oxides are not utilized). Examples of the initiator include water, glycerine, ethylene glycol, propylene glycol, trimethylolpropane, pentaerythritol or combinations thereof. The initiator can have functionality of 2 to 4.

The high ethylene oxide content polyether polyol has a nominal, e.g., average, hydroxyl functionality of 2 to 4. All individual values and subranges from two to four are included; for example, the high ethylene oxide content polyether polyol can have a nominal hydroxyl functionality from a lower limit of 2.0, 2.5, or 2.8 to an upper limit of 4.0, 3.5, or 3.2. One or more embodiments provide the high ethylene oxide content polyether polyol has a nominal hydroxyl functionality of 3.

The high ethylene oxide content polyether polyol can be prepared using known equipment, reaction conditions, and reaction components. The high ethylene oxide content polyether polyol can be obtained commercially. An example of commercially available high ethylene oxide content polyether polyols includes, but is not limited to, high ethylene oxide content polyether polyols sold under the trade name VORANOL™, such as VORANOL™ IP625, available from The Dow Chemical Company.

The high ethylene oxide content polyether polyol can have an average hydroxyl number from 240 to 300 mg KOH/g. All individual values and subranges from 240 to 300 mg KOH/g are included; for example, the high ethylene oxide content polyether polyol can have an average hydroxyl number from a lower limit of 240, 250, or 265 mg KOH/g to an upper limit of 300, 290, or 285 mg KOH/g. Average hydroxyl number, as KOH, can be determined according to ASTM D4274. One or more embodiments provide that the high ethylene oxide content polyether polyol has an average hydroxyl number of 270 mg KOH/g.

The coated fertilizer granule compositions include a first wax layer contacting, e.g., coating, the first polyurethane layer. The first wax layer can cover, e.g., be formed on, from 90% to 100% of the surface area, e.g., outermost area, of the first polyurethane layer. All individual values and subranges from 90% to 100% are included; for example, for the first wax layer can cover from a lower limit of 90, 95, or 96% to an upper limit of 100, 99, or 98% of the surface area of the first polyurethane layer. The first polyurethane layer separates the first wax layer from the fertilizer granules. In other words, the first polyurethane layer and the first wax layer are discrete from one another.

Examples of the waxes that may be utilized for the first wax layer and the second wax layer, discussed further herein, include insect and animal waxes such as beeswax; vegetable waxes such as candelilla, carnauba, japan wax, ouricury waxes, Douglas-fir bark wax, rice-bran wax, jojoba, castor wax, and bayberry wax; mineral waxes such as montan wax, peat waxes, ozokerite and ceresin waxes, and petroleum waxes, e.g., paraffin wax, microcrystalline wax, semicrystalline wax; and synthetic waxes such as polyethylene wax, Fischer-Tropsch waxes, copolymer waxes of ethylene, propylene and/or acrylic acid, and mixture of petroleum wax with ethylene-vinyl acetate copolymer. In one group of embodiments, petroleum waxes and/or synthetic waxes are used. One or more embodiments provide that the wax is alpha olefin wax. The alpha olefin wax may be a straight chain hydrocarbon having from 20 to 30 carbons.

A number of embodiments provide that the wax utilized for the first wax layer and the second wax layer are a same wax. A number of embodiments provide that the waxes utilized for the first wax layer and the second wax layer are different waxes.

The coated fertilizer granule compositions include a second polyurethane layer contacting, e.g., coating, the first wax layer. The second polyurethane layer can cover, e.g., be formed on, from 90% to 100% of the surface area, e.g., outermost area, of the first wax layer. All individual values and subranges from 90% to 100% are included; for example, for the second polyurethane layer can cover from a lower limit of 90, 95, or 96% to an upper limit of 100, 99, or 98% of the surface area of the first wax layer. The first wax layer separates the first polyurethane layer from the second polyurethane layer. In other words, the first polyurethane layer, the first wax layer, and the second polyurethane layer are discrete from one another.

Embodiments provide that the second polyurethane layer is made by reacting a high propylene oxide content polyether and a second polyurethane layer isocyanate in the presence of a second polyurethane layer tertiary amine catalyst.

As used herein, “high propylene oxide content polyether” refers to a polyether polyol that is produced by polymerization of propylene oxide and optionally another alkylene oxide and an initiator, where propylene oxide is 80 wt % or more of the total alkylene oxide content of the high propylene oxide content polyether polyol. Examples of other alkylene oxides that may be utilized include ethylene oxide, butylene oxide, and combinations thereof. Embodiments provide that the propylene oxide is from 80 to 100 wt % of the total alkylene oxide content of the high propylene oxide content polyether polyol. All individual values and subranges from 80 to 100 wt % are included; for example, the propylene oxide can be from a lower limit of 80, 90, or 95 wt % to an upper limit of 100, 99, 98, or 97 wt % of the total alkylene oxide content of the high propylene oxide content polyether polyol. One or more embodiments provide that propylene oxide is 100 wt % of the total alkylene oxide content of the high propylene oxide content polyether polyol (i.e., other alkylene oxides are not utilized). Examples of the initiator include water, glycerine, ethylene glycol, propylene glycol, trimethylolpropane, pentaerythritol or combinations thereof. The initiator can have functionality of 2 to 4.

The high propylene oxide content polyether polyol has a nominal, e.g., average, hydroxyl functionality of 2 to 4. All individual values and subranges from two to four are included; for example, the high propylene oxide content polyether polyol can have a nominal hydroxyl functionality from a lower limit of 2.0, 2.5, or 2.8 to an upper limit of 4.0, 3.5, or 3.2. One or more embodiments provide the high propylene oxide content polyether polyol has a nominal hydroxyl functionality of 3. The high propylene oxide content polyether polyol can be prepared using known equipment, reaction conditions, and reaction components. The high propylene oxide content polyether polyol can be obtained commercially. An example of commercially available high propylene oxide content polyether polyols includes, but is not limited to, high propylene oxide content polyether polyols sold under the trade name VORANOL™, such as VORANOL™ 230-238, available from The Dow Chemical Company.

The high propylene oxide content polyether polyol can have an average hydroxyl number from 210 to 650 mg KOH/g. All individual values and subranges from 210 to 650 mg KOH/g are included; for example, the high propylene oxide content polyether polyol can have an average hydroxyl number from a lower limit of 210, 215, or 225 mg KOH/g to an upper limit of 650, 600, 550, 500, 450, 400, 350, 300, 265, 260, or 250 mg KOH/g. Average hydroxyl number, as KOH, can be determined according to ASTM D4274. One or more embodiments provide that the high propylene oxide content polyether polyol has an average hydroxyl number of 240 mg KOH/g.

The coated fertilizer granule compositions include a second wax layer contacting, e.g., coating, the second polyurethane layer. The second wax layer can cover, e.g., be formed on, from 90% to 100% of the surface area, e.g., outermost area, of the second polyurethane layer. All individual values and subranges from 90% to 100% are included; for example, for the second wax layer can cover from a lower limit of 90, 95, or 96% to an upper limit of 100, 99, or 98% of the surface area of the second polyurethane layer. The second polyurethane layer separates the first wax layer from the second wax layer. In other words, the second polyurethane layer, the first wax layer, and the second wax layer are discrete from one another.

The coated fertilizer granule compositions include a third polyurethane layer contacting, e.g., coating, the second wax layer. The third polyurethane layer can cover, e.g., be formed on, from 90% to 100% of the surface area, e.g., outermost area, of the second wax layer. All individual values and subranges from 90% to 100% are included; for example, for the third polyurethane layer can cover from a lower limit of 90, 95, or 96% to an upper limit of 100, 99, or 98% of the surface area of the second layer. The second wax layer separates the second polyurethane layer from the third polyurethane layer. In other words, the second polyurethane layer, the second wax layer, and the third polyurethane layer are discrete from one another.

The third polyurethane layer is made by reacting castor oil and a third polyurethane layer isocyanate in the presence of a third polyurethane layer tertiary amine catalyst. Castor oil is a biobased polyol having hydroxyl functionality.

Castor oil can be obtained commercially. An example of commercially available castor oil includes, but is not limited to, castor oil sold by Sigma Aldrich.

As mentioned, a first polyurethane layer isocyanate is utilized to make the first polyurethane layer, a second polyurethane layer isocyanate is utilized to make the second polyurethane layer, and a third layer isocyanate is utilized to make the third polyurethane layer. The first polyurethane layer isocyanate, the second polyurethane layer isocyanate, and the third polyurethane layer isocyanate may be a same isocyanate or may be different isocyanates.

Suitable isocyanates include polyisocyanates, which have an average of greater than 1.0 isocyanate groups per molecule. Examples of suitable isocyanates include, but are not limited to, polymethylene polyphenylisocyanate, toluene 2,4-/2,6-diisocyanate (TDI), methylenediphenyl diisocyanate (MDI), polymeric MIDI, triisocyanatononane (TIN), naphthyl diisocyanate (NDI), 4,4′-diisocyanatodicyclohexylmethane, 3-isocyanatomethyl-3,3,5-trimethylcyclohexyl isocyanate (isophorone diisocyanate IPDI), tetramethylene diisocyanate, hexamethylene diisocyanate (HDI), 2-methylpentamethylene diisocyanate, 2,2,4-trimethylhexamethylene diisocyanate (THDI), dodecamethylene diisocyanate, 1,4-diisocyanatocyclohexane, 4,4′-diisocyanato-3,3′-dimethyldicyclohexylmethane, 4,4′-diisocyanato-2,2-dicyclohexylpropane, 3-isocyanatomethyl-1-methyl-1-isocyanatocyclohexane (MCI), 1,3-diisooctylcyanato-4-methylcyclohexane, 1,3-diisocyanato-2-methylcyclohexane, and combinations thereof. among others. One or more embodiments provide that the first polyurethane layer isocyanate, the second polyurethane layer isocyanate, and the third polyurethane layer isocyanate are a polymethylene polyphenylisocyanate that contains methylene biphenyl diisocyanate.

As mentioned, the isocyanate can have an average functionality of greater than 1.0 isocyanate groups per molecule. For instance, the isocyanate can have an average functionality from 1.5 to 5.0. All individual values and subranges from 1.5 to 5.0 are included; for example, the isocyanate can have an average functionality from a lower limit of 1.5, 1.7, 2.0, 2.3, or 2.5 to an upper limit of 5.0, 4.5, 4.0, 3.5, or 3.0.

The isocyanate can have an isocyanate equivalent weight 80 g/eq to 200 g/eq. All individual values and subranges from 80 to 200 g/eq are included; for example, the isocyanate can have an isocyanate equivalent weight from a lower limit of 80, 90, 100, 115, or 120 to an upper limit of 200, 175, 160, 150, or 145 g/eq.

The isocyanate can have an NCO content from 20 to 45 wt % based on a total weight of the isocyanate. All individual values and subranges from 20 to 45 wt % are included; for example, the isocyanate can have an NCO a lower limit of 20, 25, or 30 wt % to an upper limit of 45, 40, or 35 wt % based on a total weight of the isocyanate.

The isocyanate may be prepared by a known process. The isocyanate may be obtained commercially. Examples of commercial isocyanates include, but are not limited to, polyisocyanates under the trade names VORANATE™, VORACOR™, such as VORACOR CL 100 or VORACOR CE 101, and PAPI™, such as PAPI 27, available from The Dow Chemical Company, among other commercial isocyanates.

The isocyanate may be utilized to provide an isocyanate index from 120 to 160. All individual values and subranges from 120 to 160 are included; for example, the isocyanate may be utilized to provide an isocyanate index from a lower limit of 120, 130, or 135 to an upper limit of 160, 150, or 145. One or more embodiments provide that the isocyanate may be utilized to provide an isocyanate index of 140. Isocyanate index may be determined as [isocyanate groups/active hydrogen groups×100]. Active hydrogen groups include those from the high ethylene oxide content polyether polyol, the high propylene oxide content polyether polyol, the castor oil, and the tertiary amine catalyst(s).

A first polyurethane layer tertiary amine catalyst is utilized to make the first polyurethane layer, a second polyurethane layer tertiary amine catalyst is utilized to make the second polyurethane layer, and a third layer tertiary amine catalyst is utilized to make the third polyurethane layer. The first polyurethane layer tertiary amine catalyst, the second polyurethane layer tertiary amine catalyst, and the third polyurethane layer tertiary amine catalyst may be a same tertiary amine catalyst or may be different tertiary amine catalysts.

Examples of tertiary amine catalysts include triethanolamine, triisopropanolamine, N-methyl-diethanolamine, N-ethyl-diethanolamine, and N,N-dimethyl-ethanolamine. For each of the first, second, and third polyurethane layers, the tertiary amine catalyst may be from 5 to 15 wt %, based upon a total weight of the tertiary amine catalyst and the respective polyol, i.e. the high ethylene oxide content polyether polyol, the high propylene oxide content polyether polyol, or the castor oil, utilized. All individual values and subranges from 5 to 15 wt % are included; for example, for each of the first, second, and third polyurethane layers the tertiary amine catalyst may be from a lower limit of 5, 7, or 9 wt % to an upper limit of 15, 13, or 11 wt % based upon a total weight of the tertiary amine catalyst and the respective polyol utilized. One or more embodiments provide that for each of the first, second, and third polyurethane layers the tertiary amine catalyst is 10 wt % based upon a total weight of the tertiary amine catalyst and the respective polyol utilized.

Embodiments provide that the high ethylene oxide content polyether polyol is from 9 to 18 wt % based upon a total weight of a combination of the polyurethane forming components, i.e., the high ethylene oxide content polyether polyol, the high propylene oxide content polyether polyol, the castor oil, the isocyanate, and the tertiary amine catalyst. All individual values and subranges from 9 to 18 wt % are included; for example, the high ethylene oxide content polyether polyol can be from a lower limit of 9, 11, or 13 wt % to an upper limit of 18, 16, or 14 wt % based upon the total weight of the combination of the polyurethane forming components.

Embodiments provide that the high propylene oxide content polyether polyolis from 9 to 18 wt % based upon a total weight of a combination of the polyurethane forming components, i.e., the high ethylene oxide content polyether polyol, the high propylene oxide content polyether polyol, the castor oil, the isocyanate, and the tertiary amine catalyst. All individual values and subranges from 9 to 18 wt % are included; for example, the high propylene oxide content polyether polyol can be from a lower limit of 9, 11, or 13 wt % to an upper limit of 18, 16, or 15 wt % based upon the total weight of the combination of the polyurethane forming components.

Embodiments provide that the castor oil is from 11 to 20 wt % based upon a total weight of a combination of the polyurethane forming components, i.e., the high ethylene oxide content polyether polyol, the high propylene oxide content polyether polyol, the castor oil, the isocyanate, and the tertiary amine catalyst. All individual values and subranges from 11 to 20 wt % are included; for example, the castor oil can be from a lower limit of 11, 13, or 15 wt % to an upper limit of 20, 18, or 17 wt % based upon the total weight of the combination of the polyurethane forming components.

Embodiments provide that the tertiary amine catalyst is from 2 to 8 wt % based upon a total weight of a combination of the polyurethane forming components, i.e., the high ethylene oxide content polyether polyol, the high propylene oxide content polyether polyol, the castor oil, the isocyanate, and the tertiary amine catalyst. All individual values and subranges from 2 to 8 wt % are included; for example, the tertiary amine catalyst can be from a lower limit of 2, 3, or 4 wt % to an upper limit of 8, 7, or 6 wt % based upon the total weight of the combination of the polyurethane forming components.

Embodiments provide that a combination of the first polyurethane layer, the second polyurethane layer, and the third polyurethane layer is from 2.0 to 3.5 wt % based upon a total weight of the coated fertilizer granule composition. All individual values and subranges from 2.0 to 3.5 wt % are included; for example, the combination of the first polyurethane layer, the second polyurethane layer, and the third polyurethane layer can be from a lower limit of 2.0, 2.3, or 2.5 wt % to an upper limit of 3.5, 3.2, or 2.9 wt % based upon the total weight of the coated fertilizer granule composition.

Embodiments provide that a combination of the first wax layer and the second wax layer is from 0.2 to 0.8 wt % based upon a total weight of the coated fertilizer granule composition. All individual values and subranges from 0.2 to 0.8 wt % are included; for example, the combination of the first wax layer and the second wax layer can be from a lower limit of 0.2, 0.3, or 0.4 wt % to an upper limit of 0.8, 0.7, or 0.6 wt % based upon the total weight of the coated fertilizer granule composition.

Embodiments provide that the coated fertilizer granule compositions can be made by various processes. The coated fertilizer granule compositions can be made utilizing known equipment, conditions, and components.

For instance, the coated fertilizer granule compositions can be made by utilizing a drum coater. Uncoated fertilizer granules can be added to the drum coater. Subsequently, components, e.g., the high ethylene oxide content polyether polyol, the first polyurethane layer isocyanate, and the first polyurethane layer tertiary amine catalyst, utilized to make the first polyurethane layer can be added to the drum coater. These components may be added to the drum coater by various processes. As an example, the high ethylene oxide content polyether polyol and the first polyurethane layer tertiary amine catalyst may be combined to form a mixture; then a portion of the first polyurethane layer isocyanate may be added to the drum coater, followed by addition of the entire mixture to the drum coater, then followed by addition of the remaining first polyurethane layer isocyanate to the drum coater. Subsequently, components, e.g., the first layer wax, utilized to make the first wax layer can be added to the drum coater. Subsequently, components, e.g., the high propylene oxide content polyether polyol, the second polyurethane layer isocyanate, and the second polyurethane layer tertiary amine catalyst, utilized to make the second polyurethane layer can be added to the drum coater. These components may be added to the drum coater by various processes. As an example, the high propylene oxide content polyether polyol and the second polyurethane layer tertiary amine catalyst may be combined to form a mixture; then a portion of the second polyurethane layer isocyanate may be added to the drum coater, followed by addition of the entire mixture to the drum coater, then followed by addition of the remaining second polyurethane layer isocyanate to the drum coater. Subsequently, components, e.g., the second layer wax, utilized to make the second wax layer can be added to the drum coater. Subsequently, components, e.g., the castor oil, the third polyurethane layer isocyanate, and the third polyurethane layer tertiary amine catalyst, utilized to make the third polyurethane layer can be added to the drum coater to provide a coated fertilizer granule composition comprising five concentric layers, i.e., three polyurethane layers and two wax layers (polyurethane layer/wax layer/polyurethane layer/wax layer/polyurethane layer). These components may be added to the drum coater by various processes. As an example, the castor oil and the third polyurethane layer tertiary amine catalyst may be combined to form a mixture; then a portion of the third polyurethane layer isocyanate may be added to the drum coater, followed by addition of the entire mixture to the drum coater, then followed by addition of the remaining third polyurethane layer isocyanate to the drum coater.

### Examples

In the Examples, various terms and designations for materials are used including, for instance, the following.

High ethylene oxide content polyether polyol, Polyol A, was utilized. The high ethylene oxide content polyether polyol was a glycerine initiated all ethylene oxide (EO 100 wt % of the total alkylene oxide content) feed polyol having a hydroxyl functionality of approximately 3 and an average hydroxyl number of 270 mg KOH/g.

High propylene oxide content polyether polyol, Polyol B, was utilized. The high propylene oxide content polyether polyol was a glycerine initiated all propylene oxide (PO 100 wt % of the total alkylene oxide content) feed polyol having a hydroxyl functionality of approximately 3 and an average hydroxyl number of 241 mg KOH/g.

Castor oil (obtained from Sigma Aldrich).

Tertiary amine catalyst (triethanolamine; obtained from The Dow Chemical Company).

Wax (alpha olefin wax; ALPHAPLUS C30+HA; obtained from Chevron Phillips Chemical Company LP).

PAPI™ 27 (isocyanate; polymethylene polyphenylisocyanate that contains methylene biphenyl diisocyanate (MDI); average functionality 2.7; 32.0 wt % NCO; obtained from the Dow Chemical Company).

Fertilizer (SUPERU 46-0-0; 2-4 mm uncoated urea prills; obtained from American Plant Food).

Example 1, a coated fertilizer granule composition, was prepared as follows. Fertilizer (1000 grams) was oven dried at 80° C. for 6 hours. A drum coater (16⅛-inch diameter stainless steel drum with 9⅜-inch open face; track depth of 5⅛-inch with ½-inch evenly spaced vanes (five total)) was preheated to 70° C. and the dried fertilizer was added to the drum coater. The drum coater was turned on (40 rpm) and the contents of the drum coater were maintained at 80° C.

Polyol mixture #1 (4.1 grams) was formed by combining Polyol A and tertiary amine catalyst (polyol mixture #1 contained 10 wt % tertiary amine catalyst) in a container and mixing at 2000 rpm for approximately 1 minute; polyol mixture #1 was added to a respective syringe. Isocyanate #1 (4.9 grams PAPI™ 27) was added to a respective syringe.

Polyol mixture #2 (4.3 grams) was formed by combining Polyol B and tertiary amine catalyst (polyol mixture #2 contained 10 wt % tertiary amine catalyst) in a container and mixing at 2000 rpm for approximately 1 minute; polyol mixture #2 was added to a respective syringe. Isocyanate #2 (4.7 grams PAPI™ 27) was added to a respective syringe.

Polyol mixture #3 (4.8 grams) was formed by combining castor oil and tertiary amine catalyst (polyol mixture #3 contained 10 wt % tertiary amine catalyst) in a container and mixing at 2000 rpm for approximately 1 minute; polyol mixture #3 was added to a respective syringe. Isocyanate #3 (4.2 grams PAPI™ 27) was added to a respective syringe.

With the dried fertilizer loaded drum coater at 80° C. and 40 rpm, 40 vol % of the isocyanate #1 syringe was added to the contents of the drum coater; 30 seconds later 100 vol % of the polyol mixture #1 syringe was added to the contents of the drum coater; 30 seconds later the remaining 60 vol % of the isocyanate #1 syringe was added to the contents of the drum coater (thus the components of a first polyurethane layer were added to the drum coater).

After 30 seconds, wax (2.5 grams; solid) was added to the contents of the drum coater (thus the components of a first wax layer were added to the drum coater).

After 30 seconds, 40 vol % of the isocyanate #2 syringe was added to the contents of the drum coater; 30 seconds later 100 vol % of the polyol mixture #2 syringe was added to the contents of the drum coater; 30 seconds later the remaining 60 vol % of the isocyanate #2 syringe was added to the contents of the drum coater (thus the components of a second polyurethane layer were added to the drum coater).

After 30 seconds, wax (2.5 grams; solid) was added to the contents of the drum coater (thus the components of a first wax layer were added to the drum coater).

After 30 seconds, 40 vol % of the isocyanate #3 syringe was added to the contents of the drum coater; 30 seconds later 100 vol % of the polyol mixture #3 syringe was added to the contents of the drum coater; 30 seconds later the remaining 60 vol % of the isocyanate #3 syringe was added to the contents of the drum coater (thus the components of a third polyurethane layer were added to the drum coater).

After 30 seconds, the drum coater heat turned off while the 40 rpm was maintained until the contents of the drum coater were approximately 55° C. Then the drum coater rotation was stopped and the coated fertilizer granules were removed with a scoop and placed upon a tray.

The components and amounts utilized to make Example 1 (Ex 1) are reported in Table 1. Comparative Examples A-F (CE A-F) were made as Example 1, with any changes reported in Table 1.

TABLE 1

| Ex | CE | CE | CE | CE | CE | CE |
|---|---|---|---|---|---|---|
| 1 | A | B | C | D | E | F |

First Polyurethane Layer

| | | | | | | | |
|---|---|---|---|---|---|---|---|
| Polyol | 4.1 | 4.1 | — | — | — | — | 4.1 |
| mixture #1 | grams | grams | | | | | grams |
| Polyol | — | — | 4.3 | — | — | 4.3 | — |
| mixture #2 | | | grams | | | grams | |
| Polyol | — | — | — | 4.8 | 4.8 | — | — |
| mixture #3 | | | | grams | grams | | |
| Isocyanate | 4.9 | 4.9 | 4.7 | 4.2 | 4.2 | 4.7 | 4.9 |
| #1 | grams | grams | grams | grams | grams | grams | grams |

First Wax Layer

| | | | | | | | |
|---|---|---|---|---|---|---|---|
| Wax | 2.5 | 2.5 | 2.5 | 2.5 | 2.5 | 2.5 | — |
| | grams | grams | grams | grams | grams | grams | |

Second Polyurethane Layer

| | | | | | | | |
|---|---|---|---|---|---|---|---|
| Polyol | — | 4.1 | — | — | 4.1 | — | 4.1 |
| mixture #1 | | grams | | | grams | | grams |
| Polyol | 4.3 | — | 4.3 | — | — | — | — |
| mixture #2 | grams | | grams | | | | |
| Polyol | — | — | — | 4.8 | — | 4.8 | — |
| mixture #3 | | | | grams | | grams | |
| Isocyanate | 4.7 | 4.9 | 4.7 | 4.2 | 4.9 | 4.2 | 4.9 |
| #2 | grams | grams | grams | grams | grams | grams | grams |

Second Wax Layer

| | | | | | | | |
|---|---|---|---|---|---|---|---|
| Wax | 2.5 | 2.5 | 2.5 | 2.5 | 2.5 | 2.5 | 5.0 |
| | grams | grams | grams | grams | grams | grams | grams |

Third Polyurethane Layer

| | | | | | | | |
|---|---|---|---|---|---|---|---|
| Polyol | — | 4.1 | — | — | 4.1 | — | — |
| mixture #1 | | grams | | | grams | | |
| Polyol | — | — | 4.3 | — | — | — | — |
| mixture #2 | | | grams | | | | |
| Polyol | 4.8 | — | — | 4.8 | — | 4.8 | 4.8 |
| mixture #3 | grams | | | grams | | grams | grams |
| Isocyanate | 4.2 | 4.9 | 4.7 | 4.2 | 4.9 | 4.2 | 4.2 |
| #3 | grams | grams | grams | grams | grams | grams | grams |

Weight percentages (wt %) based on total
weight of polyurethane forming components

| | | | | | | | |
|---|---|---|---|---|---|---|---|
| Polyol A | 13.7 | 41.0 | — | — | 27.4 | — | 27.4 |
| Polyol B | 14.3 | — | 42.9 | — | — | 14.3 | — |
| Castor oil | 16.1 | — | — | 48.4 | 16.1 | 32.3 | 16.1 |
| Tertiary | 4.9 | 4.6 | 4.8 | 5.4 | 4.8 | 5.1 | 4.8 |
| amine | | | | | | | |
| catalyst | | | | | | | |
| Isocyanate | 51.0 | 54.4 | 52.3 | 46.2 | 51.7 | 48.3 | 51.7 |

Weight percentages (wt %) based on total
weight of coated fertilizer granules

| | | | | | | | |
|---|---|---|---|---|---|---|---|
| Combination | 2.7 | 2.7 | 2.7 | 2.7 | 2.7 | 2.7 | 2.7 |
| of First, | | | | | | | |
| Second, and | | | | | | | |
| Third | | | | | | | |
| Polyurethane | | | | | | | |
| Layers | | | | | | | |
| Combination | 0.5 | 0.5 | 0.5 | 0.5 | 0.5 | 0.5 | 0.5 |
| of | | | | | | | |
| First, and | | | | | | | |
| Second Wax | | | | | | | |
| Layers | | | | | | | |
| Isocyanate | 140 | 140 | 140 | 140 | 140 | 140 | 140 |
| index | | | | | | | |

Approximately 7 days after being made, 10 grams each of Example 1 and Comparative Examples A-F were placed in respective containers with 100 mL of deionized water. Then, at 14 days and at 28 days from being placed in the respective containers, refractive index measurements were taken to determine weight percents of released fertilizer (urea). For determining refractive index, an initial calibration curve was created by measuring the refractive index, using a refractometer, of aqueous, uncoated urea (SUPERU 46-0-0; 2-4 mm uncoated urea prills) solutions with varying concentrations. The equation was solved for the wt % of dissolved urea as follows:

$$X = \frac{Y - 1.333}{0.0013}$$

Where, X=wt % released urea. The calibration curve, which plotted urea wt % in deionized water vs refractive index, had the curve had a best fit line: y=0.0013x+1.333, and R²=0.9997.

The results are reported in Table 2.

TABLE 2

| | Fertilizer released at day | Fertilizer released at day |
|---|---|---|
| | 14 | 28 |
| Example 1 | 5 wt % | 18 wt % |
| Comparative | 32 wt % | 64 wt % |
| Example A | | |
| Comparative | 45 wt % | 63 wt % |
| Example B | | |
| Comparative | 18 wt % | 34 wt % |
| Example C | | |
| Comparative | 61 wt % | 90 wt % |
| Example D | | |
| Comparative | 38 wt % | 68 wt % |
| Example E | | |
| Comparative | 30 wt % | 75 wt % |
| Example F | | |

The data of Table 2 illustrate that Example 1 advantageously provided improved, i.e., reduced, fertilizer release at both day 14 and at day 28 as compared to each of Comparative Examples A-F.

Tack-free cure times for Polyol mixture #1 and Polyol mixture #3 with PAPI™ 27 (isocyanate index 140) were determined as the time interval over which a sample of the composition become non-tacky to the touch. The results are reported in Table 3.

TABLE 3

| | Tack- free cure time (seconds) |
|---|---|
| Polyol mixture #1/ | 131 |
| PAPI ™ 27 | |
| (isocyanate index 140) | |
| Polyol mixture #3/ | 903 |
| PAPI ™ 27 | |
| (isocyanate index 140) | |

The data of Table 3 illustrate that Polyol mixture #1 had a shorter tack-free cure time as compared to Polyol mixture #3. A relatively shorter tack-free cure time indicates a relatively increased reactivity. Because Polyol mixture #1, having a relatively shorter tack-free cure time, is utilized prior to Polyol mixture #3 when making the coated fertilizer granule compositions, productivity can advantageously be increased.

1. A coated fertilizer granule composition comprising:
a first polyurethane layer contacting fertilizer granules, wherein the first polyurethane layer is made by reacting a high ethylene oxide content polyether polyol and a first polyurethane layer isocyanate in the presence of a first polyurethane layer tertiary amine catalyst;
a first wax layer contacting the first polyurethane layer;
a second polyurethane layer contacting the first wax layer, wherein the second polyurethane layer is made by reacting a high propylene oxide content polyether polyol and a second polyurethane layer isocyanate in the presence of a second polyurethane layer tertiary amine catalyst;
a second wax layer contacting the second polyurethane layer; and
a third polyurethane layer contacting the second wax layer, wherein the third polyurethane layer is made by reacting castor oil and a third polyurethane layer isocyanate in the presence of a third polyurethane layer tertiary amine catalyst.

2. The coated fertilizer granule composition of claim 1,
wherein the first polyurethane layer isocyanate, the second polyurethane layer isocyanate, and the third polyurethane layer isocyanate are a polymethylene polyphenylisocyanate that contains methylene biphenyl diisocyanate, and the first polyurethane layer tertiary amine catalyst, the second polyurethane layer tertiary amine catalyst, and the third polyurethane layer tertiary amine catalyst are triethanolamine.

3. The coated fertilizer granule composition of claim 2, wherein ethylene oxide is from 80 to 100 wt % of a total alkylene oxide content of the high ethylene oxide content polyether polyol, the high ethylene oxide content polyether polyol has a nominal hydroxyl functionality of 2 to 4, an average hydroxyl number from 240 to 300 mg KOH/g, and is from 9 to 18 weight percent based upon a total weight of a combination of the high ethylene oxide content polyether polyol, the high propylene oxide content polyether polyol, the castor oil, and the polymethylene polyphenylisocyanate that contains methylene biphenyl diisocyanate.

4. The coated fertilizer granule composition of claim 3, wherein propylene oxide is from 80 to 100 wt % of the total alkylene oxide content of the high propylene oxide content polyether polyol, the high propylene oxide content polyether polyol has a nominal hydroxyl functionality of 2 to 4, an average hydroxyl number from 210 to 650 mg KOH/g, and is from 9 to 18 weight percent based upon the total weight of the combination of the high ethylene oxide content polyether polyol, the high propylene oxide content polyether polyol, the castor oil, and the polymethylene polyphenylisocyanate that contains methylene biphenyl diisocyanate.

5. The coated fertilizer granule composition of claim 4, wherein the castor oil is from 11 to 20 weight percent based upon the total weight of the combination of the high ethylene oxide content polyether polyol, the high propylene oxide content polyether polyol, the castor oil, and the polymethylene polyphenylisocyanate that contains methylene biphenyl diisocyanate.

6. The coated fertilizer granule composition of claim 5, wherein a combination of the first polyurethane layer, the second polyurethane layer, and the third polyurethane layer is from 2.0 to 3.5 weight percent based upon a total weight of the coated fertilizer granule composition.

7. The coated fertilizer granule composition of claim 6, wherein a combination of the first wax layer and the second wax layer is from 0.2 to 0.8 weight percent based upon the total weight of the coated fertilizer granule composition.

8. The coated fertilizer granule composition of claim 1, wherein the first polyurethane layer separates the first wax layer from the fertilizer granules, the first wax layer separates the first polyurethane layer from the second polyurethane layer, the second polyurethane layer separates the first wax layer from the second wax layer, and the second wax layer separates the second polyurethane layer from the third polyurethane layer.

9. The coated fertilizer granule composition of claim 1, wherein the fertilizer granules comprise urea.

10. A method of making the coated fertilizer granule composition of claim 1, the method comprising:
forming the first wax layer subsequently to forming the first polyurethane layer;
forming the second polyurethane layer subsequently to forming the first wax layer;
forming the second wax layer subsequently to forming the second polyurethane layer; and
forming the third polyurethane layer subsequently to forming the second wax layer.
